(19) United States
(12) Patent Application Publication
(10) Pub. No.: US 2003/0058193 A1
(43) Pub. Date: Mar. 27, 2003

(54) Plasma display panel of variable address voltage and driving method thereof

(75) Inventor: Jeong-Hyun Seo, Seoul (KR)

Correspondence Address: McGuire Woods, Suite 1800, 1750 Tysons Boulevard, McLean, VA, 22102-4215, US

(73) Assignee: Samsung SDI Co., Ltd.

(21) Appl. No.: 10/189,398

(22) Filed: Jul. 8, 2002

(30) Foreign Application Priority Data
Sep. 25, 2001 (KR) 2001-59405

(51) Int. Cl. G09G 3/28

(52) U.S. Cl. 345/60

(57) ABSTRACT

A method for driving a plasma display panel (PDP) of different address voltages that comprises a plurality of address electrodes, scan electrodes, and sustain electrodes, a scan and a sustain electrode forming a pair and being parallel with each other and crossing an address electrode, and their crossing point forming a discharge cell, comprises steps of supplying a rising ramp signal for reset discharging and a subsequent falling ramp signal to the scan electrode, and supplying voltage signals differently established according to cell colors to the address electrode during the rising ramp period to reset the respective cells, supplying an address waveform for selecting and writing cells to be turned on and off, after the reset stage,; and supplying a sustain waveform for discharging the cell set to be turned on.

### BACKGROUND OF THE INVENTION

(a) Field of the Invention

The present invention relates to a plasma display panel (PDP) of variable address voltages and a driving method thereof. More specifically, the present invention relates to a PDP and its driving method for varying voltages of address electrodes in a reset period according to red, green, and blue fluorescent material, and controlling the voltages when driving an AC PDP used as a computer monitor or a television set, thereby securely sustaining discharging and improving contrast.

(b) Description of the Related Art

The PDPs for displaying images using plasma discharge are generally categorized as DC PDPs and AC PDPs according to discharge cell structures and the waveforms of the driving voltage applied thereto. Complex configurations, inferior performance and short lifetime of the DC PDP has led to the development of AC PDPs.

As shown in FIG. 1, a general AC PDP comprises a multi-layer substrate, and provides a slimmer, lighter, and wider screen compared to the conventional screen display, the CRT.

As to a major configuration of the AC PDP with reference to FIG. 1, a scan electrode 4, a sustain electrode 5, a dielectric layer 2, a protection film 3, and an insulator layer 7 are provided in order between a first glass substrate 1 on which a discharge cell 12 is provided and a second glass substrate 6.

The scan electrode 4 and the sustain electrode 5 provided between the first glass substrate 1, the dielectric layer 2, and the protection film 3 form a pair and are arranged in parallel in the vertical direction. An address electrode 8 covered with the insulator layer 7 is installed on the second glass substrate 6 in the horizontal direction, and a barrier rib 9 is formed on the insulator layer 7 in parallel with the address electrode 8.

A fluorescent material 10 is formed on the insulator layer 7 and on both walls of the barrier rib 9, and the scan electrode 4 and the sustain electrode 5 are formed to be perpendicular to the address electrode 8, and their crossing point forms a discharge cell 12.

Therefore, as shown in FIG. 2, the scan electrode 4, the sustain electrode 5, and the address electrode 8 form the discharge cell of a matrix format.

To enhance the PDP's image quality, it is very important to improve the contrast among various factors.

The contrast is represented by the ratio of the luminance of the peak white to the darkest luminance when no sustain discharge occurs. The peak white is the maximum light mainly generated by the sustain discharge. The darkest part is determined by the light generated by the reset discharge.

Hence, the contrast is improved by making the light part lighter or the dark part darker. It can also be improved by lowering the background luminance when no discharge occurs.

A single field of a signal for driving the above-described AC PDP includes 8 to 12 sub-fields, each of which comprises four periods: a reset period, an address period, a sustain period, and an erase period.

The address period represents a period for supplying data, when selected cells are turned on in the panel and other cells are not turned on, and wall charges of the turned-on cells are accumulated. During the reset period, the respective cell are reset before providing data in the address period in order to prepare for flawless operation during the address period.

During the sustain period, cells addressed by the operation during the address period are discharged, so as to display actual images. The wall charges in the cell are reduced during the erase period to terminate the sustain and discharge operation.

FIG. 3 shows conventional PDP driving waveforms.

As shown, when a rising ramp is being supplied to the scan electrode during the reset period, the sustain electrode conventionally sustains the ground state.

In this instance, a weak discharge is generated between the address electrode and the scan electrode so that positive wall charges are accumulated in the address electrode and negative walls charges are accumulated in the scan electrode, and the sustain electrode sustains the ground state, hence accumulating a large amount of positive charges on the sustain electrode.

A reset discharge operation by the rising ramp will now be described in detail.

During the rising ramp interval, all discharge cells generate a weak discharge between the scan electrode and the address electrode and between the scan electrode and the sustain electrode, respectively. Therefore, the negative wall charges are accumulated on the scan electrode and the positive wall charges are accumulated on the address and sustain electrodes.

In a subsequent falling ramp interval, a portion of the positive charges at the address electrode is sustained and another portion of them is deleted, and the positive charges at the sustain electrode are erased through the discharging between the sustain electrode and the scan electrode, and the sustain electrode and the scan electrode share the great amount of negative charge accumulated at the scan electrode.

In this instance, in the AC PDP having 12 sub-fields, the total amount of light output generated in the ramp reset operation amounts to about 1.0 to 2 cd/m², and assuming that the luminance is 500 cd when it is bright, the darkroom contrast ratio in this case is low of from 250:1 to 500:1, which is a problem.

0 volt is are uniformly supplied to the address electrode throughout the reset period irrespective of the color of the fluorescent material.

The above conventional technique generates discharges between the address electrode and the scan electrode (or the sustain electrode) during the reset period.The discharge voltages between the address electrode and the scan electrode (or the sustain electrode) varies depending on the red, green, and blue fluorescent material.

That is, a red cell has a very low discharge voltage between the address electrode and the scan electrode compared to the blue or green cell, and the green cell has a very high discharge voltage.

Accordingly, in the conventional method, if a discharge voltage is set up according to features of the green cell, the red cell is overdischarged. This renders unstable discharge conditions that depend on driving waveforms and makes the contrast unstable.

### SUMMARY OF THE INVENTION

It is an object of the present invention to provide a PDP having address electrodes with color specific voltage in a reset period and a method for controlling the voltages when driving an AC PDP, thereby securely sustaining discharging and improving contrasts.

In order to achieve these objects, during the reset period, the present invention applies different voltages to the address electrode depending on the color of the discharge cell. The voltages applied to the address electrode of the red color cell receives higher voltage than to the address electrodes of the blue color cell or the green color cell. The present invention also discloses an apparatus for implementing such methods and a PDP that employs such an apparatus.

### BRIEF DESCRIPTION OF THE DRAWINGS

The accompanying drawings, which are incorporated in and constitute a part of the specification, illustrate an embodiment of the invention, and, together with the description, serve to explain the principles of the invention.-:

FIG. 1 shows a perspective view of a portion of an AC PDP.

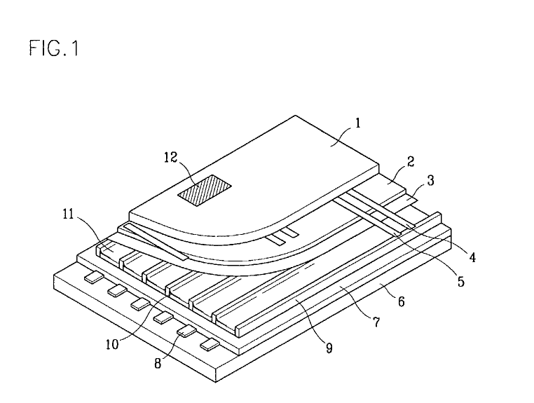

FIG. 2 shows an arrangement of electrodes on the panel.-;

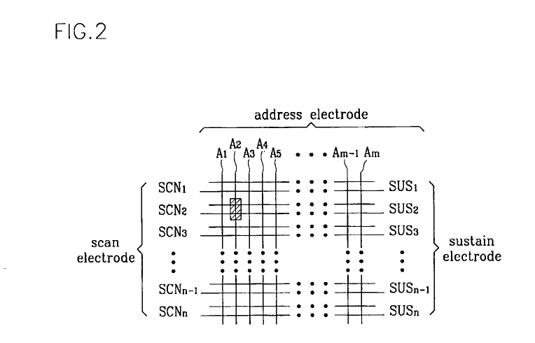

FIG. 3 shows reset driving waveforms for supplying ramp waveforms to the scan electrode of prior art.-;

FIG. 4 shows a block diagram of a PDP of variable address voltages according to a first preferred embodiment of the present invention.-;

FIG. 5 shows driving waveforms of a method for driving the PDP of variable address voltages according to the first preferred embodiment of the present invention.

FIG. 6 shows driving waveforms of a method for driving the PDP of variable address voltages according to a second preferred embodiment of the present invention.

### DETAILED DESCRIPTION OF THE PREFERRED EMBODIMENTS

In the following detailed description, only a preferred embodiment of the invention has been shown and described, simply by way of illustrating the best mode contemplated by the inventor(s). As will be realized, the invention can be modified in various obvious respects, all without departing from the invention. Accordingly, the drawings and description are to be regarded as illustrative in nature, and not restrictive.

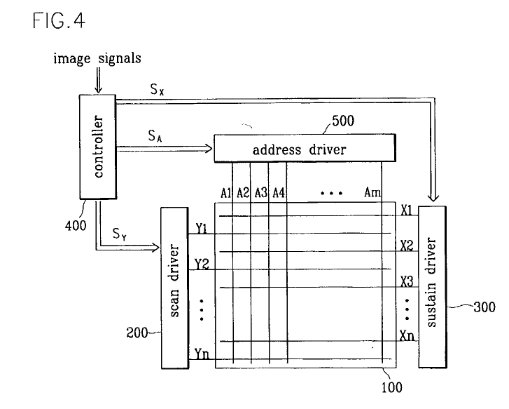

FIG. 4 shows a block diagram of a PDP of variable address voltages according to a first preferred embodiment of the present invention.

As shown, the PDP of variable address voltages comprises a plasma panel 100, a controller 400, a scan driver 200, a sustain driver 300, and an address driver 500.

The plasma panel 100 comprises a plurality of address electrodes A1 to Am provided in the column direction, and a plurality of scan electrodes Y1 to Yn and sustain electrodes X1 to Xn alternately provided in a direction.

An operation according to the first preferred embodiment will now be described.

The controller 400 receives image signals from the outside, generates an address driving signal S_{A}, a scan electrode signal S_{Y}, and a sustain electrode signal S_{X}, and respectively transmits them to the address driver 500, the scan driver 200, and the sustain driver 300.

The address driver 500 receives the address driving signal S_{A} from the controller 400, and supplies a display data signal for selecting a discharge cell to be displayed to each address electrode.

The scan driver 200 and the sustain driver 300 respectively receive the scan electrode signal S_{Y} and the sustain electrode signal S_{X} from the controller 400, and alternately input a sustain discharge voltage to the scan electrode and the sustain electrode to sustain discharging of the selected discharge cell.

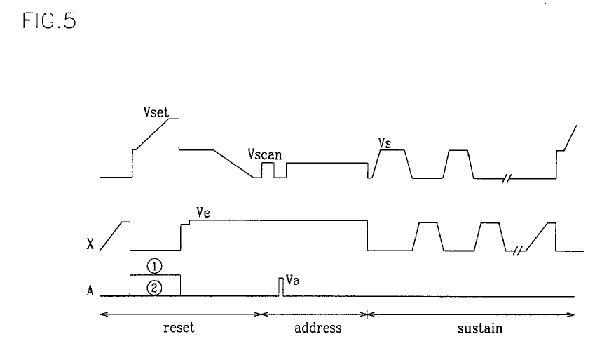

Considering the above-described operation with reference to FIG. 5, at the reset-time, the scan driver 200 provides the scan electrode with a rising ramp signal that increases the voltage from the scan reference voltage Vs to the reset setting voltage Vset, and provides the scan electrode with a falling ramp signal for reducing the voltage from the scan reference voltage Vs to the ground voltage.

The sustain driver 300 sustains the ground voltage during the rising ramp signal period of the scan driver 200, and sustains a predetermined uniform voltage Ve during the falling ramp signal period of the scan driver 200.

During the reset period, the address driver 500 controls the respective voltage supplied to each of the address electrode, depending on the color of a cell.

Referring to FIG. 5, when the scan driver 200 supplies a rising ramp signal during the reset period, the voltages of the signal provided to the address electrode from the address driver 500 are set by two methods: when the color of a cell is green or blue, the address driver 500 supplies the ground voltage of 0 volts to the address electrode as indicated by the reference numeral (2) like the conventional method; when the color of a cell is red, the address driver 500 increases the voltage to a previously established voltage and supplies it to the address electrode as indicated by the reference numeral (1).

The red cell has a lower discharge voltage than the green cell or the blue cell. Thus, if the same address voltage as to the green cell is applied address voltage with reference to the green, the red cell is over discharged. Application of different address voltage to the red cell can reduce the relative potential differences on cells.

Completing the resetting step, the address driver 500 supplies the corresponding voltage signal to the cells to be turned on.

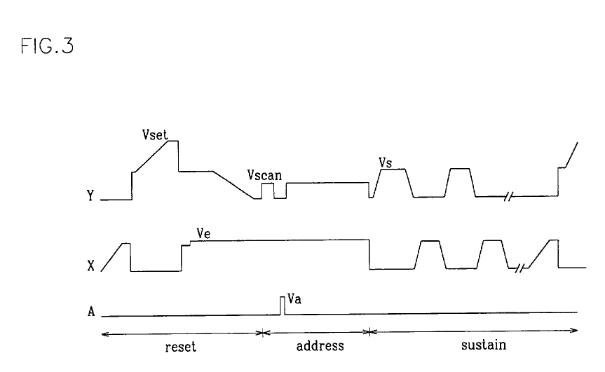

Completing the address step, the address driver 500 sustains the ground voltage, and the scan driver 200 and the sustain driver 300 respectively supply alternating waveforms to the scan electrode and the sustain electrode in the sustain period as shown in FIG. 3, thereby sustaining discharges in the addressed cell.

Completing the sustain period, the sustain driver 300 supplies an erase signal to the sustain electrode at the end of the sustain period as shown in FIG. 3 to complete the discharging.

The controller 400 starts reset control to implement a subsequent sub-field. Like the previous step, the address driver 500 supplies different signals according to the colors of the cells, and supplies to the red cell the voltage higher than the voltage supplied to other color cells, so as to reduce relative potential differences according to the features of the respective color cell.

Reduction of the potential differences among the electrodes of cells for different colors can decrease the background light, improving the contrast.

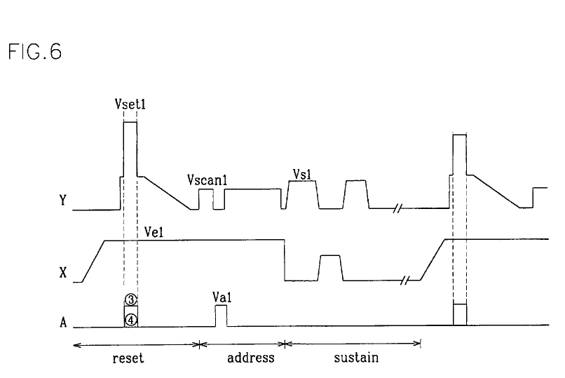

FIG. 6 shows driving waveforms different from those of FIG. 5.

Referring to FIG. 6, a second preferred embodiment will now be described.

Since the hardwired configuration of the PDP according to the second preferred embodiment is similar to that of the first preferred embodiment, no corresponding description will be provided. Its operation will be described with reference to FIG. 4 according to the first preferred embodiment.

In the second preferred embodiment, unlike the first preferred embodiment, the scan driver 200 does not supply rising ramp waveforms but supplies square waveforms to the scan electrode in the reset stage.

Like the first embodiment, the address driver 500 supplies two driving voltages to the address electrode in the reset stage.

The operation of the second preferred embodiment is as follows.

As shown in FIG. 6, in the reset period, the scan driver 200 supplies high-voltage square-wave signals to the scan electrode, and the address driver 500 supplies two voltages to the address electrode according to the colors of the cells in the reset period.

That is, the address driver 500 supplies the ground voltage of 0 volts to the address electrode of green or blue cells (4), and increases the voltage by a previously set voltage and supplies it to the address electrode of red cells (3).

As described, by varying the voltages at the address electrode according to the colors of the cells in the reset stage, the voltage higher than other color cells is supplied to the red cells, thereby preventing unneeded discharging of the red cells.

Steps after the reset stage are performed in order of the addressing period, the sustain discharge control period, and the erase period, like the first preferred embodiment. If the reset control is executed again, different voltages are supplied to the address electrode according to the cell colors.

By changing the voltages supplied to the address electrode in the reset stage, the potential differences for the respective color cells have decreased. This improves the background light amounts and enhances the corresponding contrast.

As described above, the present invention sets and controls different voltages at the address electrode in the reset period according to the red, green, and blue fluorescent material, thereby securely sustaining discharges and improving the contrast.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A method for driving a plasma display panel (PDP) of a variable address voltage that comprises an address electrode, a scan electrode, and a sustain electrode, wherein a pair of the scan electrode and the sustain electrode is formed in parallel and crosses normal to the address electrode forming a discharge cell, comprising steps of:
in a reset period, applying to the address electrode different voltages depending on a color of the discharge cell;
supplying an address waveform for selecting and writing cells to be turned on;
supplying a sustain waveform for discharging the cell that is set to be turned on in the step of supplying the address waveform.

2. The method of claim 1, further comprising steps of:
in the reset period, applying to the scan electrode a rising ramp signal and a following falling ramp signal.

3. The method of claim 1, wherein, in the reset period, voltages applied to the address electrode of a red cell are higher than those applied to other color cells.

4. The method of claim 1, further comprising steps of:
in the reset period, applying to the scan electrode a square waveform voltage signal.

5. The method of claim 4, wherein, in the reset period, voltages applied to the address electrode of a red cell are higher than those applied to other color cells.

6. A plasma display panel (PDP) of variable address voltages, comprising:
a plasma panel including an address electrode, a scan electrode, and a sustain electrode, wherein a pair of the scan electrode and the sustain electrode is formed in parallel with each other and crosses normal to the address electrode forming a discharge cell;
a controller that receives image signals from the outside, and generates an address driving signal, a scan electrode driving signal, and a sustain electrode driving signal;
an address driver that receives the address driving signal from the controller, and supplies a display data signal for selecting a discharge cell to be displayed to the address electrode;
a scan driver that receives the scan electrode driving signal from the controller, and supplies a scan voltage to the scan electrode of a cell selected to be displayed so that a sustain discharge may be performed on the selected cell; and
a sustain driver that receives the sustain electrode driving signal from the controller, and supplies a sustain voltage to the sustain electrode to sustain discharges on the selected cell,
wherein in a reset period, the address driver applies to the address electrode different voltages depending on a color of the discharge cell.

7. The PDP of claim 6, wherein in the reset period, the scan driver applies a rising ramp signal and a following falling ramp signal.

8. The PDP of claim 6, wherein voltages applied to the address electrode of a red cell are higher than those applied to other color cells.

9. The PDP of claim 6, wherein in the reset period, the scan driver applies a square waveform voltage signal and a following falling ramp signal.

10. The PDP of claim 9, wherein voltages applied to the address electrode of a red cell are higher than those applied to other color cells.
